(19) United States
(12) Patent Application Publication
(10) Pub. No.: US 2019/0225330 A1
(43) Pub. Date: Jul. 25, 2019

(54) EXTENDED FLIGHT BY REGENERATIVE LIFT FOR AN UNMANNED AERIAL VEHICLE

(71) Applicant: GoPro, Inc., San Mateo, CA (US)

(72) Inventor: Karthik Ramanathan, San Mateo, CA (US)

(21) Appl. No.: 15/915,643

(22) Filed: Mar. 8, 2018

Related U.S. Application Data
(60) Provisional application No. 62/619,335, filed on Jan. 19, 2018.

(51) Int. Cl. B64C 27/57; B64C 39/02

(52) U.S. Cl. CPC B64C 27/57; B64C 39/024; B64C 2201/146; B64C 2201/027; B64C 2201/108

(57) ABSTRACT

A dynamic propulsion system may be implemented to recover some or all of the wasted energy during a flight. The dynamic propulsion system may include one or more propellers that are configured to act as a propulsion system when altitude is rising and act as a windmill to generate energy to charge a battery during descent. The one or more propellers may include blades that are configured to adjust their angle of attack or pitch on command to switch from propulsion mode to regenerative mode and vice versa.

### CROSS REFERENCE TO RELATED APPLICATION(S)

This disclosure claims the benefit of U.S. Provisional Application No. 62/619,335, filed Jan. 19, 2018, the disclosure of which is hereby incorporated by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This disclosure relates to the detection and signaling of conditions of an unmanned aerial vehicle (UAV).

### BACKGROUND

UAVs may be used for commercial and recreational purposes. For example, a user may operate a UAV to capture photographs from higher altitudes than the user can reach by himself or herself. In another example, a user may operate a UAV to control the delivery of a good, such as to a purchaser. The UAV may include sensors to measure operational aspects of the UAV, for example, a flight altitude, an operating temperature, a rate of acceleration, or the like. These operational aspects can indicate whether the UAV is functioning as intended.

### SUMMARY

Systems and techniques for power regeneration in a UAV are described below. An example UAV system may include one or more adaptive propellers, a flight control subsystem, and one or more rotor-adaptive-propeller (RAP) systems. The adaptive propeller may be adjustable such that an angle of attack or pitch of one or more propeller blades may be adjusted based on an input.

The flight control subsystem may include one or more adaptive control modules. The one or more adaptive control modules may include an interface to receive the input. The flight control subsystem may receive the input from a sensor or from a user via remote controller. Examples of the sensor may include an inertial measurement unit (IMU), an accelerometer, a gyroscope, or an altimeter. The one or more adaptive control modules may determine a propeller mode based on the received input. The one or more adaptive control modules may transmit a signal to the one or more adaptive propulsion mechanism. The signal may be any signal that indicates the propeller mode to the one or more adaptive propulsion mechanisms, for example a pulse-width modulation (PWM) signal. The propeller mode may be a propulsion mode used to increase the altitude or direction of the UAV, or it may be a regenerative mode used to capture energy from the descent of the UAV to recharge a battery.

The one or more RAP systems may include one or more adaptive propulsion mechanisms. The one or more adaptive propulsion mechanisms may communicate with the one or more adaptive control modules and the one or more adaptive propellers. The one or more RAP systems may receive a command from the one or more adaptive propulsion mechanisms. The command may cause the one or more adaptive propellers to adjust the angle of attack or pitch of one or more propeller blades based on the indicated propeller mode. The adaptive propeller may maintain the same direction of rotation and speed in both propulsion mode and regenerative mode. The RAP system may convert kinetic energy from the adaptive propeller to charge the battery when the propeller mode is regenerative mode.

Another aspect includes a UAV system that includes one or more adaptive propellers, a flight control subsystem, one or more adaptive propulsion mechanisms, one or more power sources, and one or more RAP systems. The adaptive propeller may be adjustable such that an angle of attack or pitch of one or more propeller blades may be adjusted based on an input.

The flight control subsystem may include one or more adaptive control modules. The one or more adaptive control modules may include an interface to receive the input. The flight control subsystem may receive the input from a sensor or from a user via remote controller. Examples of the sensor may include an IMU, an accelerometer, a gyroscope, or an altimeter. The one or more adaptive control modules may determine a propeller mode based on the received input. The one or more adaptive control modules may transmit a signal to the one or more adaptive propulsion mechanism. The signal may be any signal that indicates the propeller mode to the one or more adaptive propulsion mechanisms, for example a PWM signal. The propeller mode may be a propulsion mode used to increase the altitude or direction of the UAV, or it may be a regenerative mode used to capture energy from the descent of the UAV to recharge a battery.

The one or more RAP systems may include one or more adaptive propulsion mechanisms. The one or more adaptive propulsion mechanisms may communicate with the one or more adaptive control modules and the one or more adaptive propellers. The one or more RAP systems may receive a command from the one or more adaptive propulsion mechanisms. The command may cause the one or more adaptive propellers to adjust the angle of attack or pitch of one or more propeller blades based on the indicated propeller mode. The adaptive propeller may maintain the same direction of rotation and speed in both propulsion mode and regenerative mode. The RAP system may convert kinetic energy from the adaptive propeller to charge the battery when the propeller mode is regenerative mode.

Another aspect includes a UAV system that includes one or more RAP systems. Each of the RAP systems may include an adaptive propulsion mechanism, an adaptive propeller, or both. In some implementations, a RAP system may include a single adaptive propulsion mechanism and one or more adaptive propellers, and may be configured to control one or more adaptive propellers independently or collectively. The adaptive propeller may be configured to adjust an angle of attack based on an input. The input may be received from one or more sensors, a user, or both. The input may include a state of the UAV, for example, whether the UAV is ascending or descending, whether the UAV is level, whether the UAV is drifting, or any combination of the above.

In this example, the UAV system may include a flight control subsystem that includes an adaptive control module. The flight control subsystem may be configured to receive the input. The adaptive control module may be configured to determine a UAV state based on the received input and transmit a signal to the adaptive propulsion mechanism. The signal may be a control signal that indicates a target RAP system. The adaptive propulsion mechanism may be configured to determine a propeller mode based on the UAV state.

In an example where the UAV state is determined to be ascending, the adaptive propulsion mechanism may be further configured to set the propeller mode to a first mode and transmit a signal that indicates the propeller mode to the RAP system. In an example where the UAV state is determined to be descending, the adaptive propulsion mechanism may be further configured to set the propeller mode to a second mode and transmit a signal that indicates the propeller mode to the RAP system. In UAV systems that include more than one RAP system, each RAP system may be independently controlled. For example, one or more RAP systems may be in a first mode and one or more RAP systems may be in a second mode. In these examples, the first mode may be a propulsion mode and the second mode may be a regenerative mode.

The signal transmitted to the RAP system may be a PWM signal that indicates the propeller mode. The RAP system may be configured to receive the signal from the adaptive propulsion mechanism. The signal may cause the adaptive propeller to adjust the angle of attack based on the indicated propeller mode.

The RAP system may be further configured to convert kinetic energy from the adaptive propeller to charge a battery, for example when the propeller mode is regenerative mode. In these examples, the one or more adaptive propellers may be configured to rotate in a same direction in propulsion mode and in regenerative mode.

The flight control subsystem may be further configured to receive the input from one or more sensors. For example, the one ore more sensors may include an inertial measurement unit (IMU), an accelerometer, a gyroscope, or an altimeter. The flight control subsystem may be further configured to receive the input from a remote controller.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a,” “an,” and “the” include plural referents unless the context clearly dictates otherwise.

### BRIEF DESCRIPTION OF THE DRAWINGS

The disclosed implementations have other advantages and features that will be more readily apparent from the detailed description, the appended claims, and the accompanying figures. A brief introduction of the figures is below.

FIG. 1A shows an example of a UAV.

FIG. 1B shows an example of an imaging device associated with the UAV.

FIG. 1C shows an example of a remote controller and user interface for the UAV.

FIG. 2 is a block diagram illustrating components of a computing device.

FIG. 3A is an example of a front-view of an adaptive propeller configured to regenerate energy.

FIG. 3B is another example of a front-view of an adaptive propeller configured to regenerate energy.

FIG. 4 is a chart showing an example of adaptive control voltage in regenerative mode and propulsion mode.

FIG. 5A is an example of a UAV configured to regenerate energy.

FIG. 5B is an example chart of the voltage for each propeller shown in the example UAV of FIG. 5A.

FIG. 6 is an example of a UAV system configured to perform adaptive propulsion.

All figures disclosed herein are © Copyright 2018 GoPro Inc. All rights reserved.

### DETAILED DESCRIPTION

A significant and freely available energy store for a UAV may be used at altitudes during flight. For example, according to the law of conservation of energy, the electrical energy used in raising a UAV to any height (h) will result in a proportionally stored potential energy at that height h. Typically, this potential energy is dissipated during descent without any attempt to recapture the energy for future use. Accordingly, there is an opportunity to extend the flight time of the UAV by taking advantage of this stored potential energy. In addition, UAVs may experience high variation in flight times depending on the trajectory of the UAV. For example, a UAV that maintains a constant altitude during its flight may be capable of a longer flight time than a UAV that frequently increases and decreases its flight altitude. By recapturing potential energy during any time there is a decrease in flight altitude, more reliable and constant flight times may be achieved independent of the UAV trajectory.

In an example where a user is mountaineering in the Swiss Alps, the user may wish to use the UAV to capture the beauty of the terrain and track her path ahead. In this example, given the massive mountain ranges, there will be significant vertical rise and fall in the altitude of the UAV. Accordingly, the user would require as much flight time as possible. In this example, assume a total vertical rise of 2,000 meters in a 15 minute flight, thereby wasting 2,000 meters of potential energy. A total vertical rise may be the total height risen during the course of a UAV flight including height gains after a drop in height.

To illustrate the total energy expended in a 15 minute flight, one must first calculate the total potential energy and the nominal power in a typical flight. The total potential energy may be calculated by multiplying the mass (m) of the UAV by the force of gravity (g) and the height h of travel for the UAV as shown in Equation 1 below.

Total Potential Energy=m×g×h Equation (1)

Applying Equation 1 to the example scenario above, the total potential energy is determined as 2 Kg×10 m/s²×2,000 m=40,000 joules.

The nominal power (W) in a typical flight may be calculated by multiplying voltage (V) and the current (I) as shown in Equation 2 below.

Nominal Power in typical flight=V×I Equation (2)

In this example, assuming that voltage for a typical flight is 14.8 A and current is 16 A, the nominal power for a typical flight is determined as 14.8 A×16 A=236.8 W.

The total energy expended in a 15 minute flight may then be determined by multiplying the nominal power by time as shown in Equation 3 below.

Total Energy Expended in a 15 minute flight=W×t Equation (3)

Applying Equation 3 to the example scenario above, the total energy expended in a 15 minute flight is determined as 236.8 W×(15 minutes×60 seconds)=213,120 joules. In this example scenario, 213,120 joules of total energy is expended in a 15 minute flight while 40,000 joules of energy is wasted that is potentially recoverable. Accordingly, there is a potential to recover 20-25% of the total energy and the flight time may be extended by the same amount.

A dynamic propulsion system may be implemented to recover some or all of the wasted energy. The dynamic propulsion system may include one or more propellers that are configured to act as a propulsion system when altitude is rising and act as a windmill to generate energy to charge a battery during descent. The one or more propellers may include blades that are configured to adjust their angle of attack on command to switch from propulsion mode to regenerative mode and vice versa.

For example, one or more sensors of a UAV may detect that the UAV has entered a free-fall state or that some other condition exists with respect to the UAV. A detection of entering a free-fall state may indicate to signal a switch from a propulsion mode to a regenerative mode. The regenerative mode may be used for recapturing the potential energy on descent by converting the kinetic energy of the motor to an electrical current to recharge the UAV battery.

The implementations of this disclosure will now be described in detail with reference to the drawings that are provided as illustrative examples to enable those skilled in the art to practice the technology. The figures and examples below are not meant to limit the scope of this disclosure to a single implementation, but other implementations are possible by way of interchange of or combination with some or all of the described or illustrated elements. Wherever convenient, the same reference numbers will be used throughout the drawings to refer to same or like parts.

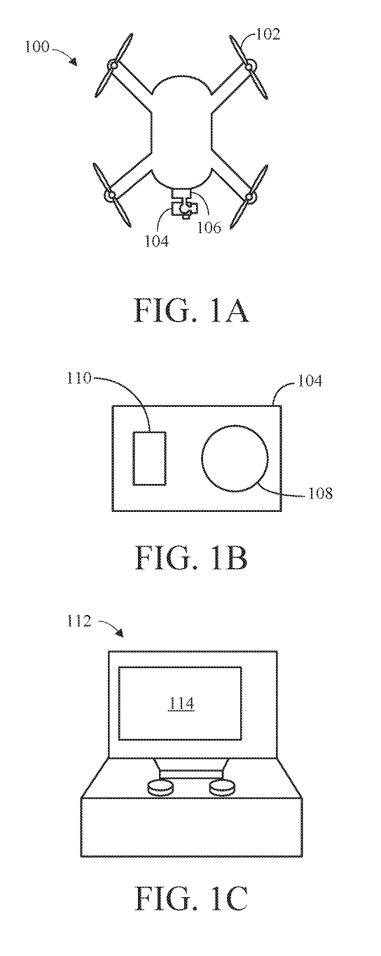

FIG. 1A shows an example of a UAV 100. In this implementation, the UAV 100 has a quad-copter configuration, that is, the UAV 100 includes four rotors 102. Other implementations may include any number of rotors. Each rotor 102 is driven by a separate electric motor (not shown). However, the UAV 100 may be any form of an aerial vehicle. A battery pack (not shown) mounted on or in a body of the UAV 100 may supply electrical power to all four electric motors, flight electronics (not shown) associated with operation of UAV 100, and an imaging device 104 that provides still and video images by means of a communication link (not shown) to a ground-based user. The imaging device 104 may be coupled to a front of the UAV 100 using, for example, a movement mechanism 106.

In FIG. 1A, the movement mechanism 106 removably mounts the imaging device 104 to the UAV 100. The implementation of the movement mechanism 106 shown in this example is a three-axis gimbal that permits the imaging device 104 to be rotated about three independent axes. However, the movement mechanism 106 may include any type of translational and/or rotational elements that permit rotational and/or translational movement in one, two, or three dimensions of the imaging device 104 in respect to the UAV 100.

FIG. 1B shows an example of the imaging device 104 associated with the UAV 100. In FIG. 1B, the imaging device 104 may be any type of imaging device 104 that can be coupled to the UAV 100, for example, through use of the movement mechanism 106. The imaging device 104 may include still image and video capture capabilities. FIG. 1B shows a lens 108 of the imaging device 104 and a display screen 110 associated with the imaging device 104. Means for coupling the imaging device 104 to the UAV 100 and/or the movement mechanism 106 are not shown.

FIG. 1C shows an example of a remote controller 112 including a user interface 114 for operating the UAV 100. The remote controller 112 may include a communications interface (not shown) via which the remote controller 112 may receive and send commands related to operation of the UAV 100, the imaging device 104, and the movement mechanism 106. The commands can include movement commands, configuration commands, operational control commands, and imaging commands. In some implementations, the remote controller 112 may be a smartphone, a tablet computer, a phablet, a smart watch, a portable computer, and/or another device configured to receive user input and communicate information with the imaging device 104, the movement mechanism 106, and/or the UAV 100.

For example, flight direction, attitude, and altitude of the UAV 100 may all be controlled by controlling speeds of the motors that drive the respective rotors 102 of the UAV 100. During flight, a global positioning satellite (GPS) receiver on the UAV 100 may provide navigational data to the remote controller 112 for use in determining flight paths and displaying current location through the user interface 114. A vision-based navigation system may also be implemented that tracks visually significant features through image data captured by the imaging device 104 to provide the necessary speed and position of the UAV 100 to the remote controller 112.

The communications interface may utilize any wireless interface configuration, e.g., WiFi, Bluetooth (BT), cellular data link, ZigBee, near field communications (NFC) link, e.g., using ISO/IEC 14443 protocol, ANT+link, and/or other wireless communications link. In some implementations, the communications interface may be effectuated using a wired interface, e.g., HDMI, USB, digital video interface, display port interface (e.g., digital display interface developed by the Video Electronics Standards Association (VESA), Ethernet, Thunderbolt), and/or other interface.

The remote controller 112 may operate a software application configured to perform a variety of operations related to camera configuration, positioning of the movement mechanism 106, control of video acquisition, and/or display of video captured by the imaging device 104 through the user interface 114. An application may enable a user to create short video clips and share video clips to a cloud service; perform full remote control of functions of the imaging device 104; live preview video being captured for shot framing; mark key moments while recording for location and/or playback of video highlights; wirelessly control camera software; and/or perform other functions. Various methodologies may be utilized for configuring the imaging device 104 and/or displaying the captured information.

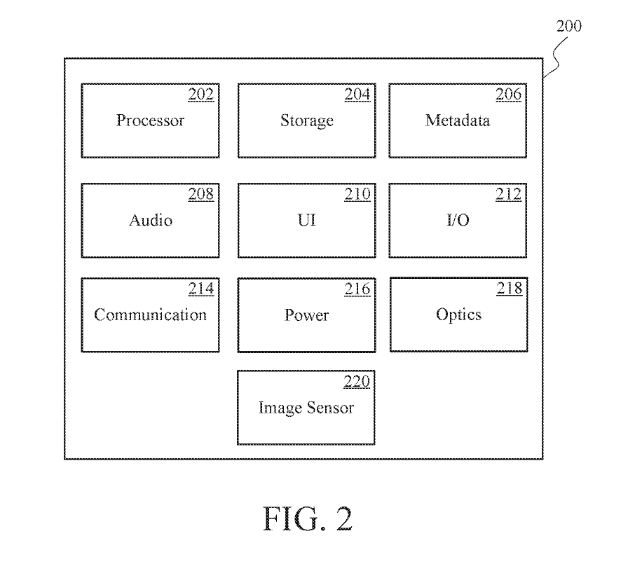

FIG. 2 is a block diagram illustrating components of a computing device 200. The computing device 200 may be a single component of the UAV 100, the imaging device 104, the movement mechanism 106, or the remote controller 112. The computing device 200 may be multiple computing devices distributed in various ways between the UAV 100, the imaging device 104, the movement mechanism 106, or the remote controller 112. In the examples described, the computing device 200 may provide communication and control functions to the various components described in reference to FIGS. 1A, 1B, and 1C.

The computing device 200 may include a processor 202. The processor 202 may include a system on a chip (SoC), microcontroller, microprocessor, central processing unit (CPU), digital signal processor (DSP), application-specific integrated circuit (ASIC), graphics processing unit (GPU), or other processors that control the operation and functionality of the UAV 100, the imaging device 104, the movement mechanism 106, and/or the remote controller 112. The processor 202 may interface with mechanical, electrical, sensory, and power modules via driver interfaces and software abstraction layers. Additional processing and memory capacity may be used to support these processes. These components may be fully controlled by the processor 202. In some implementations, one or more components may be operable by one or more other control processes (e.g., a GPS receiver may include a processing apparatus configured to provide position and motion information to the processor 202 in accordance with a given schedule (e.g., values of latitude, longitude, and elevation at 10 Hz.))

The computing device 200 may also include electronic storage 204 in which configuration parameters, image data, and/or code for functional algorithms may be stored. The electronic storage 204 may include a system memory module that is configured to store executable computer instructions that, when executed by the processor 202, control various functions of the UAV 100, the imaging device 104, the movement mechanism 106, and/or the remote controller 112. The electronic storage 204 may also include storage memory configured to store content (e.g., metadata, frames, video, and audio) captured by the imaging device 104 or sensors associated with the UAV 100, the movement mechanism 106, and/or the remote controller 112.

The electronic storage 204 may include non-transitory memory configured to store configuration information and processing code configured to enable video information and metadata capture. The configuration information may include capture type (video, frames), image resolution, frame rate, burst setting, white balance, recording configuration (e.g., loop mode), audio track configuration, and other parameters that may be associated with audio, video, and metadata capture. Additional electronic storage 204 may be available for other hardware, firmware, or software needs of the UAV 100, the imaging device 104, the movement mechanism 106, and/or the remote controller 112. The memory and processing capacity may aid in management of processing configuration (e.g., loading, replacement) operations during a startup and/or other operations.

The computing device 200 may include or be in communication with metadata sources 206. The metadata sources 206 may include sensors associated with the UAV 100, the imaging device 104, and/or the movement mechanism 106. The sensors may include an inertial measurement unit (IMU), an accelerometer, a gyroscope, a barometer, a magnetometer, a compass, a LIDAR sensor, a GPS receiver, an altimeter, an ambient light sensor, a temperature sensor, a pressure sensor, a heart rate sensor, a depth sensor (such as radar, an infra-red-based depth sensor, such as a Kinect-style depth sensor, and a stereo depth sensor), and/or other sensors. The imaging device 104 may also provide metadata sources 206, e.g., image sensors, a battery monitor, storage parameters, and other information related to camera operation and capture of content. The metadata sources 206 may obtain information related to an environment of the UAV 100 and aspects in which the content is captured.

By way of a non-limiting example, an accelerometer may provide motion information including acceleration vectors from which velocity vectors may be derived, and a barometer may provide pressure information from which elevation may be derived. A gyroscope may provide orientation information, a GPS sensor may provide GPS coordinates and time for identifying location, and an altimeter may obtain altitude information. The metadata sources 206 may be rigidly coupled to the UAV 100, the imaging device 104, the movement mechanism 106, and/or the remote controller 112 such that the processor 202 may be operable to synchronize various types of information received from various types of metadata sources 206.

For example, using timing information, metadata information may be related to content (frame or video) captured by an image sensor. In some implementations, the metadata capture may be decoupled from the video or frame capture. That is, metadata may be stored before, after, and in-between one or more video clips or frames. In one or more implementations, the processor 202 may perform operations on the received metadata to generate additional metadata information. For example, the processor 202 may integrate received acceleration information to determine a velocity profile of the imaging device 104 during a recording of a video.

The computing device 200 may include or be in communication with audio sources 208, such as one or more microphones, configured to provide audio information that may be associated with images acquired by the imaging device 104 or commands provided by the remote controller 112. Two or more microphones may be combined to form a microphone system that is directional. Such a directional microphone system may be used to determine the location of a sound source and to eliminate undesirable noise originating in a particular direction. Various audio filters may be applied as well. In some implementations, audio information may be encoded using advanced audio coding (AAC), arc consistency algorithm 3 (AC3), Moving Picture Experts Group Layer-3 Audio (MP3), linear pulse-code modulation (PCM), Moving Picture Experts Group H (MPEG-H), and other audio coding formats (audio codec.) In one or more implementations of spherical video and audio, the audio codec may include a 3-dimensional audio codec. For example, an Ambisonics codec can produce full surround audio including a height dimension. Using a G-format Ambisonics codec, a special decoder may not be required.

The computing device 200 may include or be in communication with a user interface (UI) 210. The UI 210 may include a display configured to provide information related to operation modes (e.g., camera modes, flight modes), connection status (e.g., connected, wireless, wired), power modes (e.g., standby, sensor, video), metadata sources 206 (e.g., heart rate, GPS, barometric), and/or other information associated with the UAV 100, the imaging device 104, the movement mechanism 106, and/or the remote controller 112. In some implementations, the UI 210 may include virtually any device capable of registering inputs from and communicating outputs to a user. These may include, without limitation, display, touch, gesture, proximity, light, sound receiving/emitting, wired/wireless, and/or other input/output devices. The UI 210 may include a display, one or more tactile elements (e.g., joysticks, switches, buttons, and/or virtual touch screen buttons), lights (e.g., light emitting diode (LED), liquid crystal display (LCD), or the like), speakers, and/or other interface elements.

The UI 210 may be configured to enable the user to provide commands to the UAV 100, the imaging device 104, and/or the movement mechanism 106. For example, the user interface 114 shown in FIG. 1C is one example of the UI 210. User commands provided using the UI 210 may be encoded using a variety of approaches, including but not limited to duration of a button press (pulse-width modulation), number of button presses (pulse code modulation), or a combination thereof. For example, two short button presses through the UI 210 may initiate a sensor acquisition mode. In another example, a single short button press may be used to communicate (i) initiation of video or frame capture and cessation of video or frame capture (toggle mode) or (ii) video or frame capture for a given time duration or number of frames (burst capture). Other user command or communication implementations may also be realized, such as one or more short or long button presses or toggles of a joystick.

The computing device 200 may include an input/output (I/O) module 212. The I/O module 212 may be configured to synchronize the imaging device 104 with the remote controller 112, a second capture device, a smartphone, and/or a video server. The I/O module 212 may be configured to communicate information to and from various I/O components. The I/O module 212 may include a wired or wireless communications interface (e.g., Wi-Fi, Bluetooth, USB, HDMI, Wireless USB, Near Field Communication (NFC), Ethernet, a radio frequency transceiver, and other interfaces) configured to communicate with one or more external devices. The I/O module 212 may interface with LED lights, a display, a button, a microphone, speakers, and other I/O components. In one or more implementations, the I/O module 212 may be coupled to an energy source such as a battery or other DC electrical source.

The computing device 200 may include a communication module 214 coupled to the I/O module 212. The communication module 214 may include a component (e.g., a dongle) having an infrared sensor, a radio frequency transceiver and antenna, an ultrasonic transducer, and/or other communications interfaces used to send and receive wireless communication signals. In some implementations, the communication module 214 may include a local (e.g., Bluetooth, Wi-Fi, or the like) or broad range (e.g., 3G, Long Term Evolution (LTE) or the like) communications interface configured to enable communications between the UAV 100, the imaging device 104, the movement mechanism 106, and/or the remote controller 112.

The communication module 214 may employ communication technologies including one or more of Ethernet, 802.11, worldwide interoperability for microwave access (WiMAX), 3G, LTE, digital subscriber line (DSL), asynchronous transfer mode (ATM), InfiniBand, peripheral component interconnect (PCI) Express Advanced Switching, and/or other communication technologies. By way of non-limiting example, the communication module 214 may employ networking protocols including one or more of multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and/or other networking protocols.

Information exchanged over the communication module 214 may be represented using formats including one or more of hypertext markup language (HTML), extensible markup language (XML), and/or other formats. One or more exchanges of information between the imaging device 104 and outside devices, such as the remote controller 112, may be encrypted using encryption technologies including one or more of secure sockets layer (SSL), transport layer security (TLS), virtual private networks (VPNs), Internet Protocol security (IPsec), and/or other encryption technologies.

The computing device 200 may include a power system 216 that may moderate a power supply based on the needs of the UAV 100, the imaging device 104, the movement mechanism 106, and/or the remote controller 112. For example, a battery, solar cell, inductive (contactless) power source, rectification, or other power supply housed within the UAV 100 may be controlled by the power system 216 to supply power for the imaging device 104 and/or the movement mechanism 106 when in a coupled state as shown in FIG. 1A.

Implementations of the computing device 200 may include additional, fewer, or different components than shown in FIG. 2. In some implementations, the computing device 200 may include optics. For example, the optics may include a lens, such as the lens 108 shown in FIG. 1B. The lens may, for example, include a standard lens, macro lens, fisheye lens, zoom lens, special-purpose lens, telephoto lens, prime lens, achromatic lens, apochromatic lens, process lens, wide-angle lens, ultra-wide-angle lens, infrared lens, ultraviolet lens, perspective control lens, or the like.

In some implementations, the computing device 200 may include an image sensor. For example, the image sensor may be a charge-coupled device (CCD) sensor, active pixel sensor (APS), complementary metal-oxide semiconductor (CMOS) sensor, N-type metal-oxide-semiconductor (NMOS) sensor, or the like, or a combination thereof. The image sensor may be configured to capture light waves gathered by optics of the computing device 200 and generate image data based on control signals from a sensor controller. For example, the optics may include focus controller functionality configured to control the operation and configuration of a lens, such as for receiving light from an object and transmitting the received light to the image sensor. The image sensor may use the received light to generate an output signal conveying visual information regarding an object. For example, the visual information may include one or more of an image, a video, and other visual information.

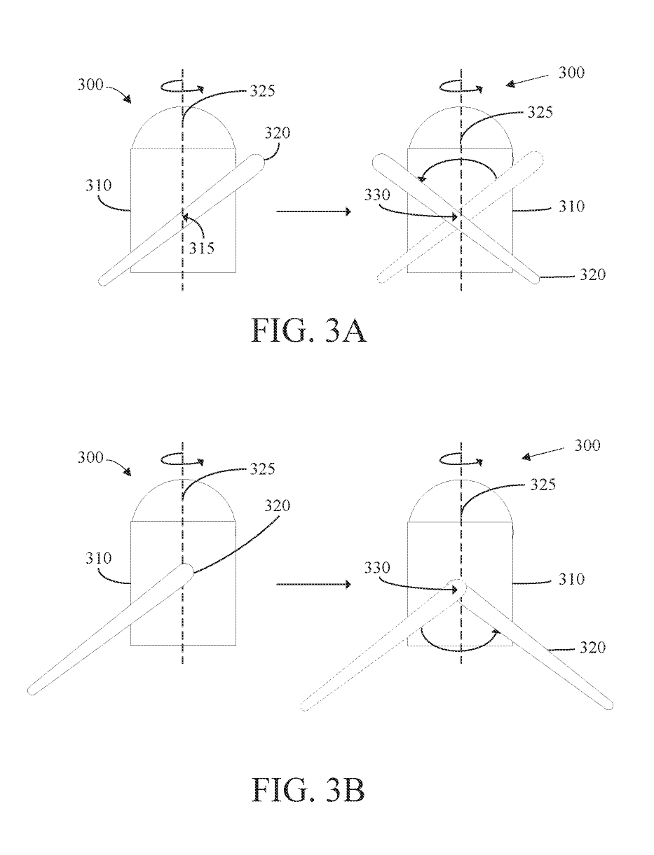

FIGS. 3A and 3B are examples of a front-view of an adaptive propeller 300 configured to regenerate energy. The propeller 300 comprises a shaft 310 and a blade 320. The shaft 310 is configured to rotate on an axis 325. In this view, a single blade 320 is shown for simplicity and it is understood that the adaptive propeller 300 may include multiple blades. The blade 320 is mechanically coupled to the shaft 310 and configured to rotate on an axis 330 to adjust the pitch of the blade 320 and switch from a first mode to a second mode. In this example, the axis 330 is shown near an approximate center point 315 of the blade 320. It is understood that the axis 330 is not limited to the approximate center point 315 of the blade 320 and may be located anywhere along the blade 320 as shown in FIG. 3B. The pitch may also be referred to as an angle of attack. The first mode may be a propulsion mode that is used when the altitude of the UAV is increasing. In propulsion mode, energy is discharged from the battery and used to propel the UAV. The second mode may be a regenerative mode that is used when the altitude of the UAV is decreasing. In regenerative mode, the propeller is configured to convert the kinetic energy during descent into usable electricity to charge the battery. As shown in FIGS. 3A and 3B, the direction of rotation of the shaft 310 on axis 325 remains unchanged when switching from the first mode to the second mode.

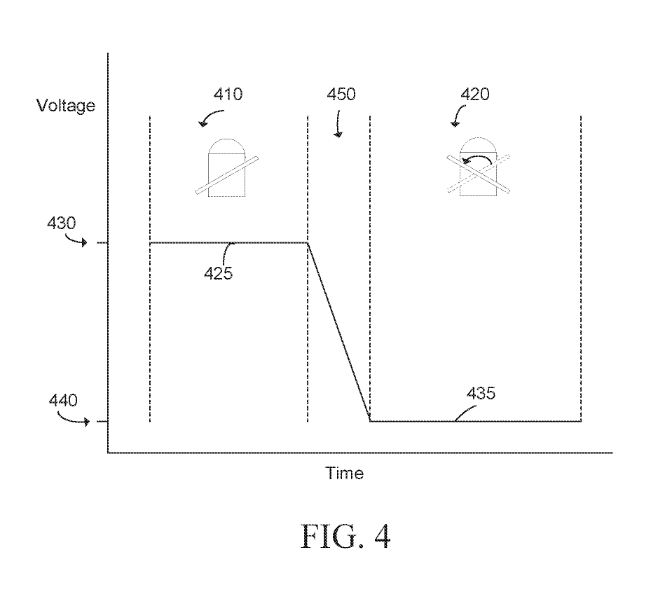

The adaptive propeller 300 may be controlled by an electrical signal shown in FIG. 4. FIG. 4 is a chart showing an example of adaptive control voltage in a propeller that transitions from a regenerative mode 410 to a propulsion mode 420. To enter regenerative mode 410, the propeller receives a first signal 425 at a regenerative voltage 430. To enter propulsion mode 420, the propeller receives a second signal 435 at a propulsion voltage 440. There may be a transition period 450 between regenerative mode 410 and propulsion mode 420 as the pitch of the propeller blade is adjusted. The first signal 425 and the second signal 435 may each be pulse-width modulation (PWM) signals.

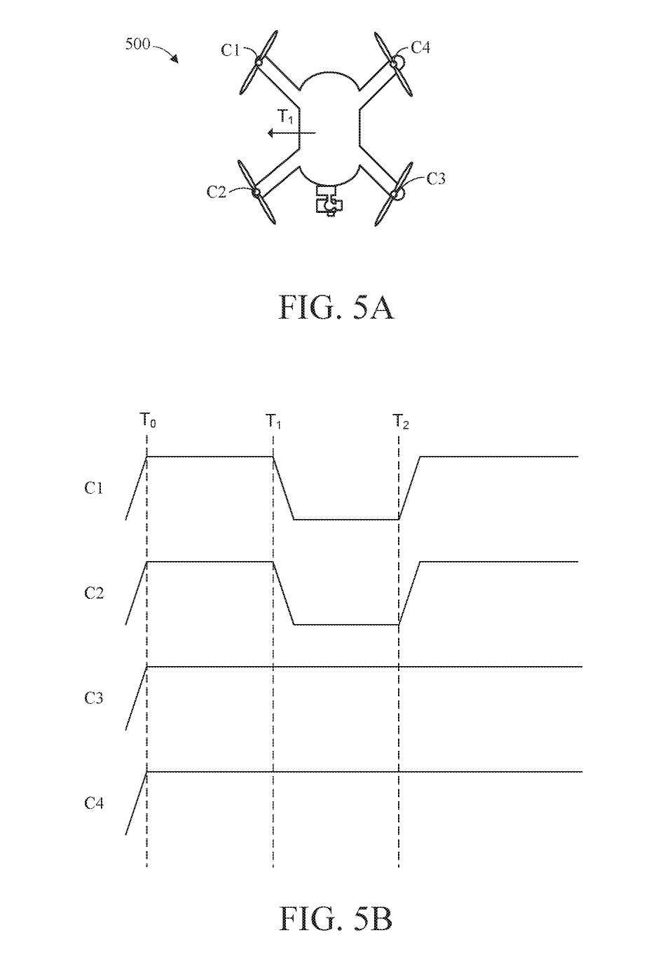

FIG. 5A is an example of a UAV 500 configured to perform adaptive propulsion to regenerate energy. The UAV 500 is shown with a first rotor-adaptive-propeller (RAP) system C1, a second RAP system C2, a third RAP system C3, and a fourth RAP system C4. Each of the four RAP systems C1-C4 includes a rotor and an adaptive propeller that may be independently controlled. Each adaptive propeller includes a mechanism configured to adjust the angle of each blade to switch the adaptive propeller from propulsion mode to regenerative mode or vice versa. Control of the RAP systems C1-C4 may be coordinated by an adaptive propulsion mechanism 510. PWM signals may be sent to each RAP system to switch the respective propeller from regenerative mode to propulsion mode or vice versa.

In an example scenario, one or more sensors in the UAV 500 may detect that the UAV 500 is tilting to the left at time T₁. FIG. 5B is an example chart of the voltage for each rotor-adaptive-propeller system C1-C4 when UAV 500 of FIG. 5A detects at time T₁ that it is tilting. Referring to FIG. 5B, at T₀, the UAV 500 is in descent and all four rotor-adaptive-propeller systems C1-C4 are in regenerative mode. At T₁, one or more sensors of the UAV 500 detect that the UAV 500 is tilting to the left. In order to compensate for the tilt and level the UAV 500, a signal is sent at T₁ to each of RAP systems C1 and C2. The signals may be PWM signals that indicate to each of RAP systems C1 and C2 to switch the respective propellers from regenerative mode to propulsion mode. In this example scenario, RAP systems C3 and C4 are unchanged and remain in regenerative mode. At T₂, one or more sensors of the UAV 500 detect that the UAV 500 is no longer tilting, and accordingly a signal is sent to each of RAP systems C1 and C2. These signals may be PWM signals that indicate to each of RAP systems C1 and C2 to switch the respective propellers from propulsion mode to regenerative mode.

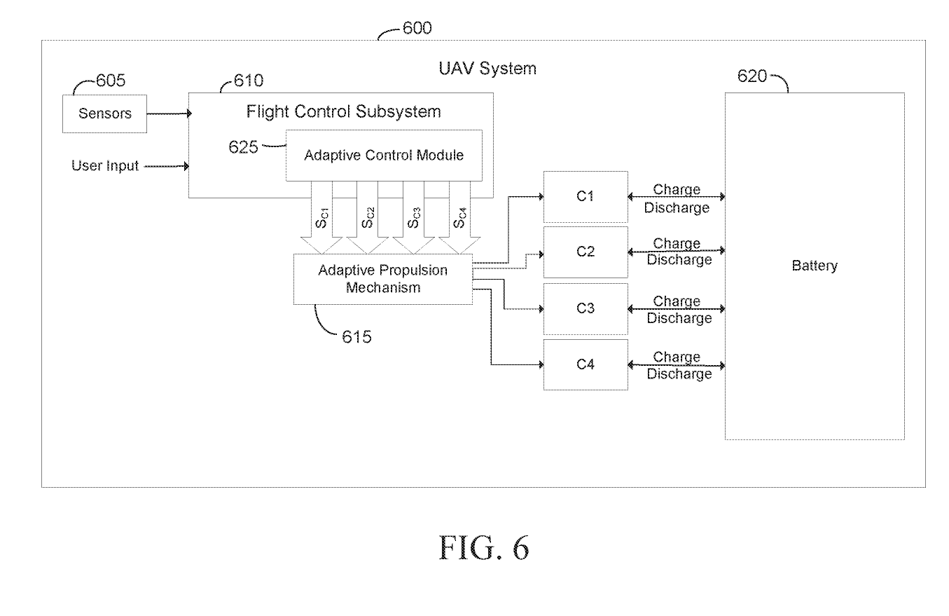

FIG. 6 is an example of a UAV system 600 configured to perform adaptive propulsion. The UAV system 600 includes one or more sensors 605, a flight control subsystem 610, an adaptive propulsion mechanism 615, and a battery 620. The UAV system 600 is an example of a system that may be found in UAV 500 shown in FIG. 5A having a first RAP system C1, a second RAP system C2, a third RAP system C3, and a fourth RAP system C4, each electrically coupled to the adaptive propulsion mechanism 615. Each of the four RAP systems C1-C4 includes a rotor and an adaptive propeller that may be independently controlled. Control of the RAP systems C1-C4 may be coordinated by the adaptive propulsion mechanism 615. In some examples, the RAP systems and adaptive propulsion mechanism may be combined. For example, the RAP systems C1-C4 may each include an adaptive propulsion mechanism. Alternatively, the adaptive propulsion mechanism 615 may include each of RAP systems C1-C4.

As shown in FIG. 6, the flight control subsystem 610 includes an adaptive control module 625 that is electrically coupled to the adaptive propulsion mechanism 615. The flight control subsystem 610 is configured to receive input from the one or more sensors 605. The one or more sensors 605 may include an IMU, an accelerometer, a gyroscope, a barometer, a magnetometer, a compass, a LIDAR sensor, a GPS receiver, an altimeter, an ambient light sensor, a temperature sensor, a pressure sensor, a heart rate sensor, a depth sensor (such as radar, an infra-red-based depth sensor, such as a Kinect-style depth sensor, and a stereo depth sensor), and/or other sensors. The flight control subsystem 610 is also configured to receive input from a user, for example via a remote controller. The user input may include, for example, a command to increase or decrease altitude, a command to increase or decrease the pitch of the UAV, a command to adjust the yaw and/or roll of the UAV, or any combination of these commands.

The adaptive control module 625 determines whether to use regenerative mode or propulsion mode for each of RAP systems C1-C4 based on the input received from the one or more sensors 605, the user, a state of the UAV, or any combination. A state of the UAV includes, but is not limited to, whether the UAV is ascending or descending, whether the UAV is tilting, whether the UAV is drifting, or any combination. The adaptive control module 625 generates a signal based on the determination and transmits the signal to the adaptive propulsion mechanism 615. In some implementations, the adaptive propulsion mechanism 615 may determine whether to use regenerative mode or propulsion mode based on the input received from the one or more sensors 605, the user, a state of the UAV, or a combination. In this example, signals S_{C1}, S_{C2}, S_{C3}, and S_{C4} are shown. Signal S_{C1} may be a PWM signal that indicates a mode to RAP system C1. Signal S_{C2} may be a PWM signal that indicates a mode to RAP system C2. Signal S_{C3} may be a PWM signal that indicates a mode to RAP system C3. Signal S_{C4} may be a PWM signal that indicates a mode to RAP system C4.

The adaptive propulsion mechanism 615 receives signals SC1, SC2, SC3, and SC4, and coordinates control of the RAP systems C1-C4 by indicating the mode to each respective RAP system C1-C4. The indicated mode may be a propeller mode, for example propulsion mode or regenerative mode. Upon receiving the signal, each RAP system C1-C4 is configured to adjust the pitch of the respective adaptive propeller blade based on the signal. RAP system C1 is configured to convert the kinetic energy from the respective propeller to charge battery 620 when it is in regenerative mode. RAP system C2 is configured to convert the kinetic energy from the respective propeller to charge battery 620 when it is in regenerative mode. RAP system C3 is configured to convert the kinetic energy from the respective propeller to charge battery 620 when it is in regenerative mode. RAP system C4 is configured to convert the kinetic energy from the respective propeller to charge battery 620 when it is in regenerative mode. The RAP systems C1-C4 may operate independently or in coordination with each other.

Where certain elements of these implementations may be partially or fully implemented using known components, only those portions of such known components that are necessary for an understanding of this disclosure have been described. Detailed descriptions of other portions of such known components have been omitted so as not to obscure the disclosure.

An implementation showing a singular component in this disclosure should not be considered limiting; rather, this disclosure is intended to encompass other implementations including a plurality of the same component, and vice-versa, unless explicitly stated otherwise herein. Further, this disclosure encompasses present and future known equivalents to the components referred to herein by way of illustration.

As used herein, the term “bus” is meant generally to denote all types of interconnection or communication architecture that may be used to communicate data between two or more entities. The “bus” could be optical, wireless, infrared or another type of communication medium. The exact topology of the bus could be for example standard “bus,” hierarchical bus, network-on-chip, address-event-representation (AER) connection, or other type of communication topology used for accessing, e.g., different memories in a system.

As used herein, the term “computing device” is meant to include personal computers (PCs) and minicomputers, whether desktop, laptop, or otherwise, mainframe computers, workstations, servers, personal digital assistants (PDAs), handheld computers, embedded computers, programmable logic device, personal communicators, tablet computers, portable navigation aids, J2ME equipped devices, cellular telephones, smart phones, personal integrated communication or entertainment devices, or literally any other device capable of executing a set of instructions.

As used herein, the term “computer program” or “software” is meant to include any sequence or machine cognizable steps which perform a function. Such program may be rendered in virtually any programming language or environment including, for example, C/C++, C#, Fortran, COBOL, MATLAB™, PASCAL, Python, assembly language, markup languages (e.g., HTML, SGML, XML, VoXML), as well as object-oriented environments such as the Common Object Request Broker Architecture (CORBA), Java™ (including J2ME, Java Beans), Binary Runtime Environment (e.g., BREW).

As used herein, the terms “connection,” “link,” “transmission channel,” “delay line,” and “wireless” mean a causal link between any two or more entities (whether physical or logical/virtual) which enables information exchange between the entities.

As used herein, the terms “integrated circuit,” “chip,” and “IC” are meant to refer to an electronic circuit manufactured by the patterned diffusion of trace elements into the surface of a thin substrate of semiconductor material. By way of non-limiting example, integrated circuits may include field programmable gate arrays (FPGAs), programmable logic devices (PLDs), reconfigurable computer fabrics (RCFs), SoCs, application-specific integrated circuits (ASICs), and/or other types of integrated circuits.

As used herein, the term “memory” includes any type of integrated circuit or other storage device adapted for storing digital data including, without limitation, ROM, PROM, EEPROM, DRAM, Mobile DRAM, SDRAM, DDR/2 SDRAM, EDO/FPMS, RLDRAM, SRAM, “flash” memory (e.g., NAND/NOR), memristor memory, and PSRAM.

As used herein, the terms “processor,” “microprocessor,” and “digital processor” are meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., FPGAs), PLDs, RCFs, array processors, secure microprocessors, ASICs, and/or other digital processing devices. Such digital processors may be contained on a single unitary IC die, or distributed across multiple components.

As used herein, the terms “network interface” and “communications interface” refer to any signal, data, and/or software interface with a component, network, and/or process. By way of non-limiting example, a communications interface may include one or more of FireWire (e.g., FW400, FW110, and/or other variation.), USB (e.g., USB2), Ethernet (e.g., 10/100, 10/100/1000 (Gigabit Ethernet), 10-Gig-E, and/or other Ethernet implementations), MoCA, Coaxsys (e.g., TVnet™), radio frequency tuner (e.g., in-band or OOB, cable modem, and/or other protocol), Wi-Fi (802.11), WiMAX (802.16), PAN (e.g., 802.15), cellular (e.g., 3G, LTE/LTE-A/TD-LTE, GSM, and/or other cellular technology), IrDA families, and/or other communications interfaces.

As used herein, the term “Wi-Fi” includes one or more of IEEE-Std. 802.11, variants of IEEE-Std. 802.11, standards related to IEEE-Std. 802.11 (e.g., 802.11 a/b/g/n/s/v), and/or other wireless standards.

As used herein, the term “wireless” means any wireless signal, data, communication, and/or other wireless interface. By way of non-limiting example, a wireless interface may include one or more of Wi-Fi, Bluetooth, 3G (3GPP/3GPP2), HSDPA/HSUPA, TDMA, CDMA (e.g., IS-95A, WCDMA, and/or other wireless technology), FHSS, DSSS, GSM, PAN/802.15, WiMAX (802.16), 802.20, narrowband/FDMA, OFDM, PCS/DCS, LTE/LTE-A/TD-LTE, analog cellular, CDPD, satellite systems, millimeter wave or microwave systems, acoustic, infrared (i.e., IrDA), and/or other wireless interfaces.

As used herein, the terms “imaging device” and “camera” may be used to refer to any imaging device or sensor configured to capture, record, and/or convey still and/or video imagery which may be sensitive to visible parts of the electromagnetic spectrum, invisible parts of the electromagnetic spectrum (e.g., infrared, ultraviolet), and/or other energy (e.g., pressure waves).

While certain aspects of the implementations described herein are in terms of a specific sequence of steps of a method, these descriptions are only illustrative of the broader methods of the disclosure and may be modified as required by the particular applications thereof. Certain steps may be rendered unnecessary or optional under certain circumstances. Additionally, certain steps or functionality may be added to the disclosed implementations, or the order of performance of two or more steps permuted. All such variations are considered to be encompassed within the disclosure.

While the above detailed description has shown, described, and pointed out novel features of the disclosure as applied to various implementations, it will be understood that various omissions, substitutions, and changes in the form and details of the devices or processes illustrated may be made by those skilled in the art without departing from the disclosure. The foregoing description is in no way meant to be limiting, but rather should be taken as illustrative of the general principles of the technologies.

What is claimed is:

1. An unmanned aerial vehicle (UAV) system comprising:
a rotor-adaptive-propeller (RAP) system that includes an adaptive propulsion mechanism and an adaptive propeller configured to adjust an angle of attack based on an input;
a flight control subsystem that includes an adaptive control module and is configured to receive the input, wherein the adaptive control module is configured to determine a UAV state based on the received input and transmit a control signal to the adaptive propulsion mechanism, wherein the control signal indicates a target RAP system;
wherein the adaptive propulsion mechanism is configured to determine a propeller mode based on the UAV state.

2. The UAV system of claim 1, wherein on a condition that the UAV state is determined to be ascending, the adaptive propulsion mechanism is further configured to set the propeller mode to a first mode and transmit a signal that indicates the propeller mode to the RAP system; and
on a condition that the UAV state is determined to be descending, the adaptive propulsion mechanism is further configured to set the propeller mode to a second mode and transmit a signal that indicates the propeller mode to the RAP system.

3. The UAV system of claim 2, wherein the RAP system is configured to receive the signal from the adaptive propulsion mechanism, wherein the signal causes the adaptive propeller to adjust the angle of attack based on the indicated propeller mode.

4. The UAV system of claim 2, wherein the signal is a pulse-width modulation (PWM) signal that indicates the propeller mode.

5. The UAV system of claim 4, wherein the first mode is propulsion mode and the second mode is regenerative mode.

6. The UAV of claim 5, wherein the RAP system is further configured to convert kinetic energy from the adaptive propeller to charge a battery on a condition that the propeller mode is regenerative mode.

7. The UAV system of claim 5, wherein the adaptive propeller is configured to rotate in a same direction in propulsion mode and in regenerative mode.

8. The UAV system of claim 1, wherein the flight control subsystem is further configured to receive the input from a sensor.

9. The UAV system of claim 8, wherein the sensor is an inertial measurement unit (IMU), an accelerometer, a gyroscope, or an altimeter.

10. The UAV system of claim 1, wherein the flight control subsystem is further configured to receive the input from a remote controller.

11. An unmanned aerial vehicle (UAV) system comprising:
an adaptive propeller configured to adjust an angle of attack based on an input;
a flight control subsystem that includes an adaptive control module and is configured to receive the input;
an adaptive propulsion mechanism electrically coupled to the adaptive control module;
a power source; and
a rotor-adaptive-propeller (RAP) system that is electrically coupled to the adaptive propulsion mechanism and the power source.

12. The UAV system of claim 11, wherein the flight control subsystem is further configured to receive the input from a sensor.

13. The UAV system of claim 12, wherein the sensor is an inertial measurement unit (IMU), an accelerometer, a gyroscope, or an altimeter.

14. The UAV system of claim 11, wherein the flight control subsystem is further configured to receive the input from a remote controller.

15. The UAV system of claim 11, wherein the adaptive control module is further configured to transmit a signal to the adaptive propulsion mechanism.

16. The UAV system of claim 15, wherein the signal is a pulse-width modulation (PWM) signal that indicates the propeller mode to the adaptive propulsion mechanism.

17. The UAV system of claim 16, wherein the propeller mode is propulsion mode or regenerative mode.

18. The UAV system of claim 17, wherein the adaptive propeller is configured to rotate in a same direction in propulsion mode and in regenerative mode.

19. The UAV system of claim 16, wherein the RAP system is configured to receive a command from the adaptive propulsion mechanism, wherein the command causes the adaptive propeller to adjust the angle of attack based on the indicated propeller mode.

20. The UAV of claim 19, wherein the RAP system is further configured to convert kinetic energy from the adaptive propeller to charge the power source on a condition that the propeller mode is regenerative mode.
